(19) United States
(12) Patent Application Publication
(10) Pub. No.: US 2019/0130283 A1
(43) Pub. Date: May 2, 2019

(54) DATA COLLECTION AND SHARING SYSTEM AND METHOD OF USE

(71) Applicant: Terrell Ozell Mitchell, Humble, TX (US)

(72) Inventor: Terrell Ozell Mitchell, Humble, TX (US)

(21) Appl. No.: 16/178,061

(22) Filed: Nov. 1, 2018

Related U.S. Application Data
(60) Provisional application No. 62/580,380, filed on Nov. 1, 2017.

(51) Int. Cl. G06N 5/02; G06F 17/30

(52) U.S. Cl. CPC G06N 5/02; H04L 63/101; G06F 17/30598

(57) ABSTRACT

A system for keeping and using data of a deceased person beyond the death of the deceased person includes a network having a server and a database; a first computing device in communication with the network; a platform accessible from the first computing device, the platform having a registration portal to receive an identifying data from a user; a profile creation portal to receive data associated with categories from the user; and a settings portal having an access granting mechanism; the user can select one or more persons from a list within the access granting mechanism; and the one or more persons receive access to the user's profile upon the death of the user.

### BACKGROUND

### 1. Field of the Invention

The present invention relates generally to data collection systems, and more specifically, to a data collection system for sharing, among other things, photos, important documents, and voice recordings, with desired persons upon death. The system of the present invention further provides a data collection system to transmit data collected through an artificial intelligence (AI) engine to create an AI file for innumerous uses.

### 2. Description of Related Art

Data collection systems are well known in the art and are effective means to keep and record information. For example, social networks are common in the art and provide a means for users to upload and store data, such as photos, for future use and for sharing with others.

One of the problems commonly associated with conventional data collection systems is the lack of useful purposes for the collected data upon the death of a user. For example, when the user of a social network passes away, their profile and all data stored therein remains unavailable for use.

Accordingly, although great strides have been made in the area of data collection systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a data collection system in accordance with the present application;

FIG. 2 is a simplified schematic of the features of the platform of FIG. 1;

FIG. 3 is a simplified schematic of the system of FIG. 2 in use with an artificial intelligence engine;

FIG. 4 is a flowchart of the method of use of the system of FIG. 1 by a first user; and

FIG. 5 is a flowchart of the method of use of the system of FIG. 1 by a second user.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional data collection systems. Specifically, the present invention provides a means to collect data for sharing and use by others upon the passing of a first user. In addition, the present invention provides a system for the collection of data for use within an artificial intelligence system. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

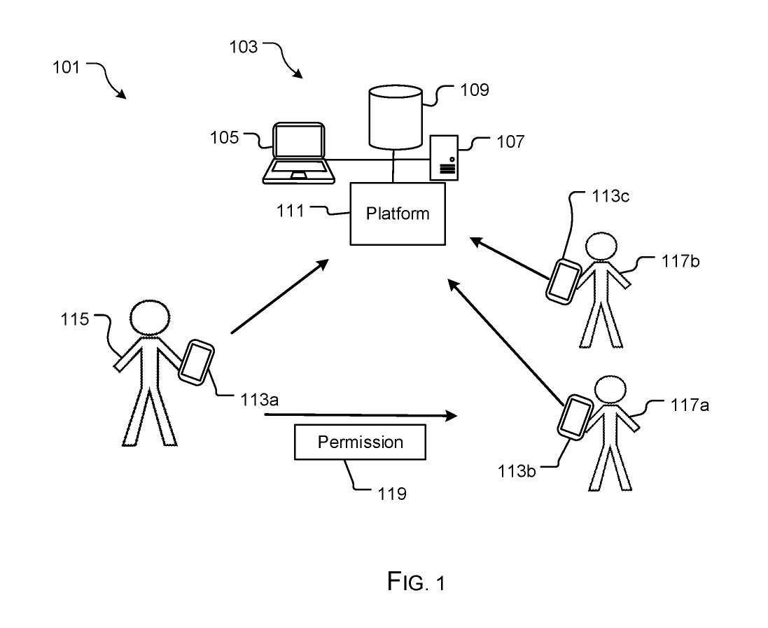

Referring now to the drawings wherein like reference characters identify corresponding or similar elements throughout the several views, FIG. 1 depicts a simplified schematic of a data collection and sharing system 101 in accordance with a preferred embodiment of the present application. It will be appreciated that system 101 overcomes one or more of the above-listed problems commonly associated with conventional data collection systems.

In the contemplated embodiment, system 101 includes a network 103 having one or more of a computing device 105, a server 107, and a database 109, wherein the various components are configured to receive, store, and execute analysis of data. System 101 further includes a platform 111 accessible from a plurality of computing devices 113a-c. It should be appreciated that platform 111 can be a mobile application and/or a website.

System 101 is configured to allow a first user 115 to register and create a profile within platform 111. Secondary users 117a, 117b can also register and create profiles within platform 111, thereby connecting the first user and the secondary users. It should be appreciated that the user profiles can be used for sharing and updating information between users, similar to a social media sharing platform.

Within platform 111, first user 115 can grant permission 119 to one or more of the secondary users, wherein the permission allows the one or more secondary users access to information upload and recorded within platform 111 by the first user. In the preferred embodiment, platform 111 is programmed to automatically grant access upon the death of user 115. It should be understood that this feature allows for the first user to leave behind data, information, memories, etc. for access by the one or more designated secondary users.

It should be appreciated that one of the unique features believed characteristic of the present application is the features allowing for designation of one or more persons to receive some or all information stored within the database and accessible through platform 111. It should be appreciated that this feature allows for a user to select persons to receive some or all data associated with their profile.

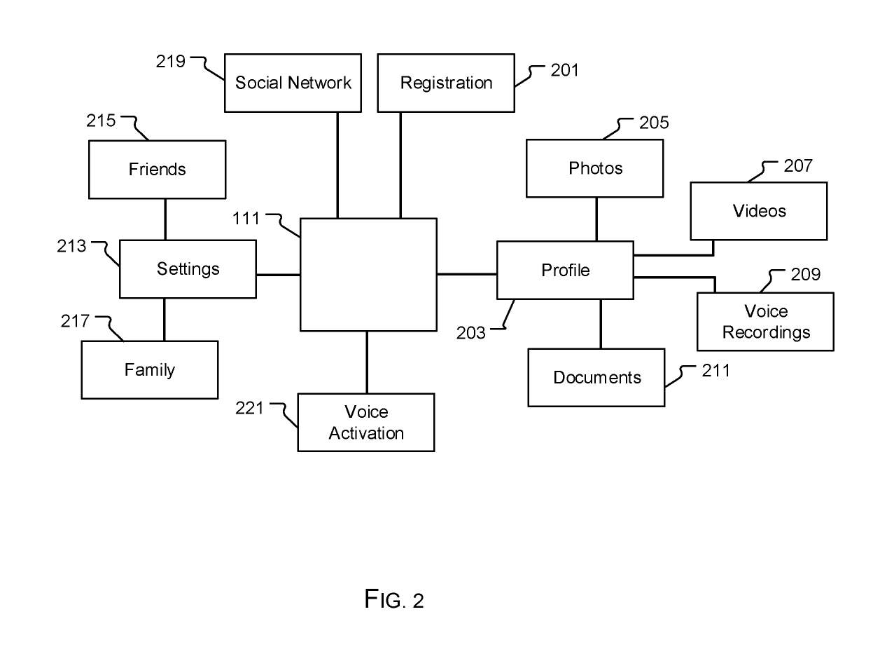

In FIG. 2, a simplified schematic shows some of the features contemplated to be included within platform 111. Platform 111 includes at least a registration portal 201 and a profile development portal 203. It should be appreciated that these two portals could be combined into one, or alternatively, could be two separate portals. Registration portal 201 is configured to receive identifying information, such as name, address, phone number, email address, or any other identifying information.

In the preferred embodiment, profile development portal 203 can be configured to receive extensive data files associated with the user and categorize said data files. Some contemplated categories include photos 205, videos 207, voice recordings 209, and important documents 211. It is contemplated that the important document category can include files such as an estate will, insurance policies, bank account documentation, professional contact information, and the like, thereby providing the important documents needed during estate distribution of the first user.

In one embodiment, the plurality of data files are tagged and/or labeled with an appropriate heading, thereby allowing for quick recall of the various data files via one of the users.

Platform 111 further includes a settings portal 213, wherein the user can designate one or more friends 215, and/or one or more family members 217 for the granting of access to data. It must be understood that the granting of permission to access data can be customizable within settings portal 213. As an example, the first user may designate one family member to have 100% access to all information and data stored within the first user's profile. Alternatively, the first user can grant access to only photos. This feature allows for the first user to control what happens to their custom data upon their death.

Platform 111 can further include a social networking portal 219, wherein users can share information and network with other users. It is contemplated that portal 219 can have an independent social network system, or alternatively can connect to existing social networks such as Instagram®, Facebook®, or others.

Another feature contemplated to incorporate into platform 111 is a voice activation mechanism 221. It is contemplated that voice activation mechanism 221 can be connected to data stored within a user's profile. For example, it is contemplated that the voice activation can provide a command associated with the one or more tags/labels attached to the plurality of data files, thereby commanding the system to recall one or more appropriate data files upon voice activation. This feature allows for a secondary user to activate a command via their voice, wherein the command causes a video or voice recording to play back to the user. It should be appreciated that every function associated with platform 111 can be connected to voice activation, thereby allowing for a user to access and enjoy each portion of the platform through voice activation.

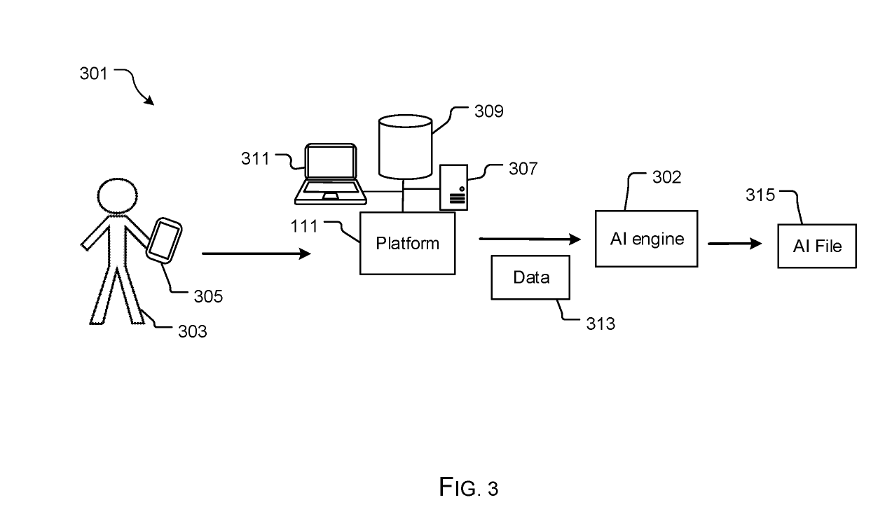

In FIG. 3, a simplified schematic demonstrates a system 301 configured to connect data collection system 101 with an artificial intelligence engine 302. In this embodiment, a first user 303 uses a computing device 305 to access platform 111, wherein platform 111 collects extensive data, as described above, this data including photos, videos, voice recordings, and other statistical information. One or more of a server 307, database 309, and computer 311, are used to transmit the extensive data 313 collected via platform 111 into AI engine 302, wherein the AI engine is configured to translate the extensive data 313 into an AI file 315 to correlate to the user. It should be appreciated that the AI file can then be used in any industry, field, or system capable of utilizing AI files.

Another unique feature believed characteristic of the present application is the use of a platform as described in system 101 to collected extensive data regarding one or more persons, wherein the data is then transmitted through an AI engine to create an AI file associated with the user.

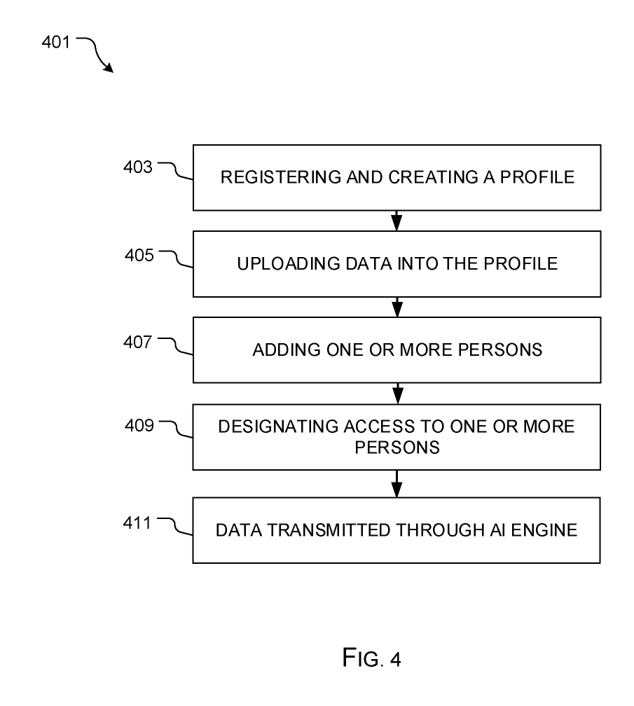

In FIG. 4, a first flowchart 401 depicts the method of use of system 101 by the first user. The first user registers and creates a profile, as shown with box 403. The user then proceeds to add data to the profile, the data including photos, videos, voice recordings, documents, and any other information the user wishes to input into the profile, as shown with box 405. The user can then add secondary users, such as friends and family, as shown with box 407. It should be appreciated that the user can either add friends and family that are secondary users with their own profiles, or alternatively can input data such as contact information associated with a person to add them to a list. The user can then designate one or more persons to receive information or access to their profile upon their death, as shown with box 409. In some embodiments, the extensive data collected through the platform is input through an AI engine to create an AI file associated with the user, as shown with box 411.

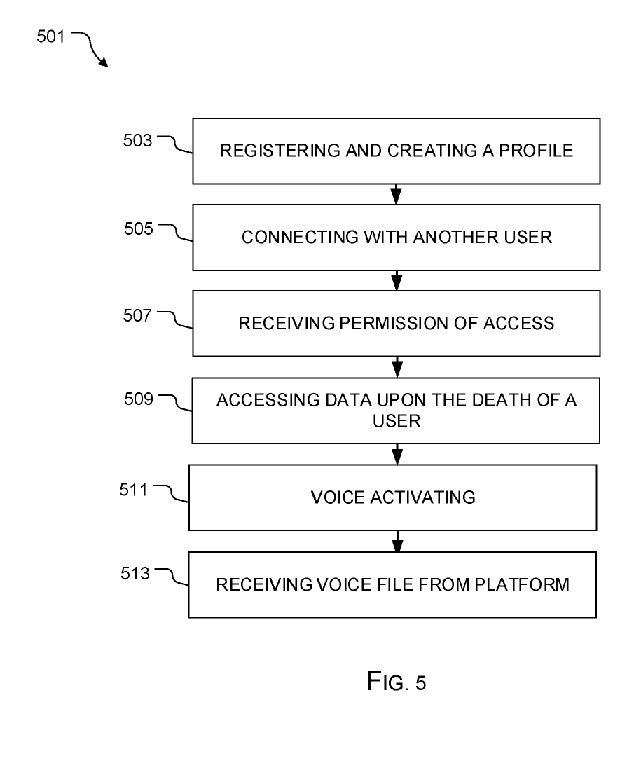

In FIG. 5, a second flowchart 501 depicts the method of use of system 101 by a secondary user. The secondary user can register and create a profile, as shown with box 503. The user can then connect with other users and receive permission from a first user, as shown with boxes 505, 507. Upon the death of the first user, the second user will receive access to designated information, such as important documents, through platform 111, as shown with box 509. The secondary user can use the voice activation feature to activate a command, wherein the secondary user can receive voice files or audio files associated with the first user, as shown with boxes 511, 513.

It should be appreciated that the various features discussed herein are non-exhaustive, and the system of the present invention can include additional features or modifications to the features described herein, while maintaining the same functionality.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system for keeping and using data of a deceased person beyond the death of the deceased person, the system comprising:
a network having a server and a database;
a first computing device in communication with the network;
a platform accessible from the first computing device, the platform having:
a registration portal configured to receive an identifying data from a user;
a profile creation portal configured to receive data associated with a plurality of categories from the user; and
a settings portal having an access granting mechanism;
wherein the user can select one or more persons from a list within the access granting mechanism; and
wherein the one or more persons receive access to the user's profile upon the death of the user.

2. The system of claim 1, wherein the plurality of categories comprises one or more of:
a photos category;
a video category;
a voice recording category; and
an important document's category.

3. The system of claim 1, wherein the platform further comprises:
a social network connection configured to connect the user with others and allow the user to share data.

4. The system of claim 1, wherein the settings platform includes one or more categories of persons to allow the user to grant access to.

5. The system of claim 4, wherein the settings platform includes contact information relating to each person within the one or more categories of persons to provide a means to alert each person.

6. The system of claim 1, wherein the platform further comprises a voice activation portal, wherein a secondary user can receive a voice recording from the user based on a voice activation command.

7. The system of claim 1, further comprising:
an artificial intelligence engine in communication with the network and configured to receive data from the platform;
wherein the artificial intelligence engine is configured to create an AI file associated with the user.

8. A method of compiling data of a deceased person, the method comprising:
providing the system of claim 1;
receiving the identifying data of the user for registration;
receiving data associated with the plurality of categories from the user; and
receiving an access designation within the setting portal, the access designation determining one or more persons to receive access to the user's profile upon the user's death.

9. The method of claim 8, wherein the data associated with the plurality of categories includes pictures, videos, voice recordings, and important documents.

10. The method of claim 8, further comprising:
receiving a voice activation from a secondary user; and
transmitting a voice recording to the secondary user.

11. The method of claim 8, further comprising:
sending data collected through the system of claim 1 through an artificial intelligence engine; and
creating an AI file associated with the user.
